(19) United States
(12) Patent Application Publication
(10) Pub. No.: US 2015/0341244 A1
(43) Pub. Date: Nov. 26, 2015

(54) Performance Analysis of a Time-Varying Network

(71) Applicant: Virtual Instruments Corporation, San Jose, CA (US)

(72) Inventors: Genti Cuni, Mountain View, CA (US); Leo Szumel, South Lake Tahoe, CA (US); Adam Schondelmayer, Campbell, CA (US)

(73) Assignee: Virtual Instruments Corporation, San Jose, CA (US)

(21) Appl. No.: 14/284,753

(22) Filed: May 22, 2014

(51) Int. Cl. H04L 12/26

(52) U.S. Cl. CPC H04L 43/0876; H04L 43/10

(57) ABSTRACT

Methods and systems are described for storing network device identities and application assignments as a function of time to facilitate analysis of network devices and applications even in a temporally dynamic network. Server assignments are stored as a function of time for various applications executed within a network. Performance data are indexed according to a server and/or port unique identifier and stored as a function of time. Using the time-based server assignments and time-based performance data, the system can be queried using at least one of an application and intermediate entity identifier to determine the performance of the application, the entity, or both at one or more points in time.

### BACKGROUND

The present disclosure relates generally to computer networks. Specifically, the present disclosure relates to performance analysis of a time-varying network.

Data networks continue to evolve with ever-higher speeds and more extensive topologies. In order to improve performance of such networks and troubleshoot problems, the performance of a network is monitored through various techniques. However, monitoring network performance is complicated by changes in the entity, device, or port executing tasks and changes in the structure of the network as a whole. Without taking into account these changes over time, performance analysis as a function of either device or computing task may not be accurate.

For example, analyzing the performance of a particular server in a fiber channel network is not particularly instructive without an understanding of the computing tasks assigned to it. In some cases, performance, whether favorable or unfavorable, is a function of the capacity to perform multiple tasks or the capability to efficiently perform a particular assigned task. In other cases, the performance of an application is analogously influenced by the network device assigned to perform the application over time.

Because the assignments of applications to particular network devices change as a function of time, and because the composition of the network itself changes as devices are added, altered, or removed, precise network analysis is challenging.

### BRIEF DESCRIPTION OF THE DRAWINGS

FIG. 1 is an illustration of a network application and its corresponding network device assignments, in an embodiment.

FIG. 2 is a block diagram of a system for analyzing network performance of network devices and applications as a function of time, in an embodiment.

FIG. 3 is a schematic illustration of a performance report for an application, in an embodiment.

FIG. 4 is an interaction diagram for a method of compiling network performance information as a function of time and analyzing it, in an embodiment.

FIG. 5 is a high level diagram of an example computing architecture for use in implementing embodiments described herein.

The figures depict various embodiments of the present disclosure for purposes of illustration only. One skilled in the art will readily recognize from the following discussion that alternative embodiments of the structures and methods illustrated herein may be employed without departing from the principles described herein.

### DETAILED DESCRIPTION

### Overview

Embodiments described herein include methods and systems for storing network identities (whether for a port, a device or a parent entity “containing” one or more devices and/or ports), network topology, and application assignments as a function of time to facilitate analysis of network devices and applications in a temporally dynamic network. In one embodiment, device assignments (and optionally the corresponding assigned ports) for various applications are stored using a timestamp or start and stop times of a monitoring period (generically described as a “time index”) and a unique monitored device identifier. While the described embodiments often refer to devices identified in the terminology of a fiber channel network, and conversations between the devices, it will be understood that these embodiments are applicable to ports, device, and entities in any of a variety of networks.

An example of a unique monitored device (or entity) identifier is a world-wide name (“WWN”) for a switch port, or an Initiator, Target, logical unit number (“LUN”) combination for a SCSI conversation. Performance data indexed according to the unique monitored device identifier is also stored using a time stamp. Using the time-based entity assignments and time-based performance data, the system can be queried to determine the performance of the entity at one or more points in time. Using a time stamp and an entity identifier as query terms is facilitated by indexing both server/port assignments and performance data using the unique monitored entity identifier. In embodiments, the entity identifiers and the performance data are stored in different database structures wherein each structure is adapted to the fast retrieval of the performance or time-based entity assignment stored therein. These data are then correlated for analysis.

Conventionally, network analytical systems store performance data indexed using an initiating entity or device, a target device, and a logical unit number, thus inconveniently requiring more specific network information which inhibits the convenient analysis of application performance.

### Application Assignments in a Network

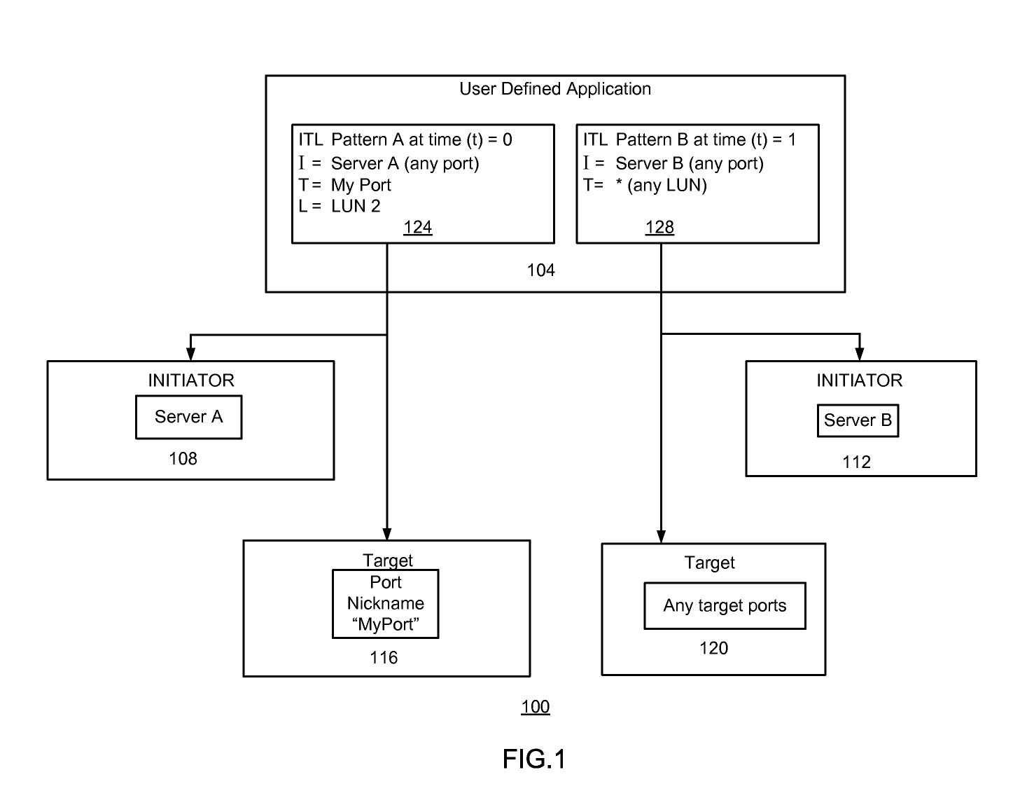

FIG. 1 illustrates a system environment 100 of a fiber channel storage area network (FC SAN) that includes a network application and its corresponding assigned network device. The system environment 100 of FIG. 1 is provided for context and to facilitate description and explanation of embodiments of the present disclosure. The system environment 100 includes a user-defined application 104, a first application initiator 108, a second application initiator 112, a first application target 116, and a second application target 120.

The user-defined application 104 is, in this example of the FC SAN environment 100, a computer executable program used for the management, maintenance, or operation of the FC SAN. In this system environment 100, as in many other types of networks, applications can be moved between devices within the system environment. This includes moving an application between initiating devices (e.g., devices providing data to be written to a storage device or providing instructions related to the writing of the data) and between destination devices (e.g., a storage device storing provided data).

The devices used by the application 104 are specified using an “ITL” (Initiator/Target/Logical Unit Number) pattern, illustrated as ITL Pattern A 124 and ITL Pattern B 128. An ITL pattern uniquely identifies a network device (in the example of an FC SAN, a server or a storage device) using a network device identifier, which in some cases includes a device name or a port name (although not each element of the ITL is required because default rules (e.g., “match any”) are applied if one or two elements are missing). For example, the ITL Pattern A 124 (corresponding to time (t)=0) of the application 104 specifies that the application will use as an initiating device any ports of server A. The ITL Pattern A 124 further specifies a target port (in the case of a SAN, a port of a storage device) identified by a user-defined nickname “myport.” In this example, ITL Pattern A 124 further specifies a specific storage location on the target device, known as a logical unit number (“LUN”), although this is optional.

However, as mentioned above, applications can be moved to various devices in the system environment 100. As such, the application 104 also includes ITL Pattern B 128 (corresponding to time (t)=1) that specifies any ports of server B as the initiating device and any port of any of target device of the system environment 100. While ITL Pattern A and ITL Pattern B are indicated by two different chronologically sequential times, t=0 and t=1, other forms of this time index are possible, such as a start time and a stop time for each pattern, or a time range. These various ways of characterizing a time dimension for the disclosed embodiments are generically termed a “time index.”

As is further illustrated in FIG. 1, application 104 executes ITL Pattern A 124 by initiating an operation using the initiating device 108 (i.e., server A). The initiating device 108 is directed to execute its instructions at the target device 116, which in this case is a port identified by user-defined nickname “MyPort”). While not shown, other identifiers (e.g., a WWN) can be used. In the event that the application 104 is re-assigned to different devices corresponding to ITL Pattern B 128 at time (t)=1, then the initiating device 112 is server B and the target device 120 includes any LUNs of the system environment 100.

Moving applications according to different ITLs at different times, such as ITLs 124 and 128 at t=0 and t=1, complicates analysis of the performance of the application 104 because the application performance is a function of, among other factors, the initiating and target devices. Without a record of which devices were assigned to execute the application 104 at which times, analysis of the performance of the application is incomplete.

### Time-Based Network Analysis System

To address this deficiency, embodiments of the present disclosure periodically store the identities of initiating devices and destination devices (and ports thereof) of an application. The information is stored at regular intervals of time and indexed according to time and the device identifiers of the ITL. Data relating to performance of a device or a conversation between devices is stored in one database configured for the storage of tabular data. Data relating to the identities of the network devices executing applications and the network topology (i.e., relationships of the network devices to each other) are stored in a database configured for the storage this type of relationship information. A benefit of storing these different types of information in separate, appropriately configured, databases is that the queries and the corresponding analysis are performed faster and more accurately than if the different types of data were stored together in a storage system configured to store only one of the types of information used to analyze application performance.

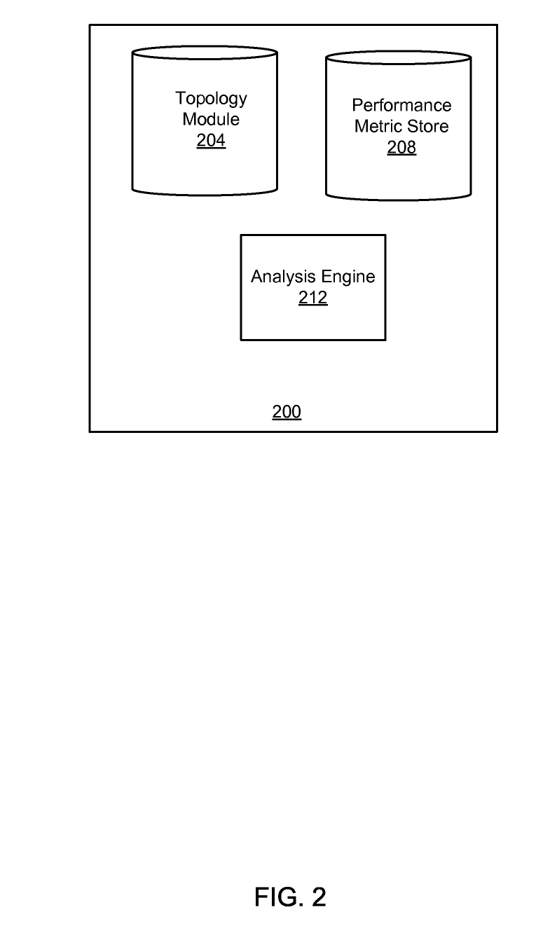

FIG. 2 is a block diagram illustrating a system 200 for analyzing network performance of network devices and applications as a function of time, thus addressing the deficiencies of conventional performance analysis systems. The system 200 includes a topology module 204, a performance metric store 208, and an analysis engine 212.

The topology module 204 is a client and a database configured for identifying and storing relational information of the various network devices, their identifiers (typically FCIDs), and the relationships to each other. The client of the topology module 204 periodically queries the devices connected to the network to determine changes to the topology. Changes to the topology are recorded such that the time-varying state of the topology is captured. Examples of such changes include: addition of new devices or changes in the relationship between entities and devices. Each change is recorded as the deletion, addition, or modification of a relationship in the topology occurring at a specific time index.

The analysis engine 212 periodically (or continuously as a background process) queries the topology module 204 for updates to the topology database. Updates that are received by the analysis module include identifications of new relationships between devices, modifications to existing relationships, and deletions of relationships that no longer exist. Each message, regardless of the type, includes identities of initiating and target devices (which can be locally or globally unique) assigned to an application, a reference to the most recent, prior application transaction, and timestamps (or, generically, a time index) corresponding to changes in the relationships. With this information, a history of topology changes can be uniquely identified as a function of time, device, and relationship. These updates are then committed to the performance metric store 208 database in a flattened, tabular format. This format consists of topology database identifiers paired with performance metric store identifiers and a time index for each entity (server, application, etc.) defined in the topology module 204. For multiple changes occurring within a time period between queries, the system can improve its efficiency by sending a single update that communicates only the topology changes since the last query are sent.

Updates to the topology are checked prior to implementation to confirm their accuracy and to prevent duplication and the possible errors resulting from duplication. For example, changes to the topology received by the client are implemented if they are timely. That is, updates received but previously implemented are ignored. Also, to preserve a record of all relationships in the topology through time, terminated relationships are not removed from the database by deletion. Rather, a corresponding end time stamp (or other end time index) is set to a start time stamp in order to indicate deletion. This allows a subsequent update related to the relationship (e.g., a re-institution of the relationship) to be sent at a later time.

Examples of databases configured to record relationship data include, but are not limited to, Neo4j, Teradata Aster, and others.

In some examples, the identifiers identifying the network devices are globally unique identifiers. In the example of an FC SAN, a globally unique device identifier is the WWN of the device, which is analogous to a MAC address in an Ethernet network. However, devices in an FC SAN typically do not transmit their WWNs frequently, transmitting them primarily upon logging into the FC SAN. A locally unique identifier, such as an FCID, that is transmitted frequently as an element of most packets sent to and from FC SAN devices is a more convenient identifier to use. Using embodiments described in U.S. patent application Ser. No. 14/253,141, titled “Automatically Determining Locations of Network Monitors in a Communication Network”, filed on Apr. 15, 2014 and incorporated by reference herein in its entirety, FCIDs are correlated with their corresponding WWN, thus uniquely identifying the devices of the topology tracked by the topology module 204.

The performance metric store 208 is a database configured for storing, in a tabular format, raw performance data of various devices and conversations between devices and the corresponding identifiers (typically FCIDs) of the devices assigned to an application at a particular time interval. Raw performance data is collected for each device and/or port by sampling and analyzing packets transmitted through the network using a network test access point and network monitor, as described in U.S. patent application Ser. No. 14/253,141. Because transmitted packets include an FCID, the raw performance data corresponding to a particular device and/or port is identified in terms of FCID and a time stamp corresponding to the operation(s) analyzed. This is then used to evaluate performance of a particular application.

The performance metric store 208 stores data from both hardware probes (i.e., network monitors connected to a network) and software probes. Hardware probes monitor traffic on communication links. In the case of a fiber channel network, hardware probes report monitored data according to Initiator, Target, and LUN. A variety of metrics can be collected by the hardware probe for each “ITL” combination. For other probe types, such as fiber channel software probes, network switches are polled for metric data. The metrics are identified or associated with the switch port WWN.

The analysis engine 212 produces an analysis of the performance for an application or a particular device in response to queries. The query can include an application name, an FCID of a port, an entity identifier, or a device name, depending on the output desired. Because the raw data stored in the topology module 204 and the performance metric store 208 is identified (or “keyed”) by a time stamp, and a port/device identifier, the stored performance data is conveniently correlated to its corresponding topology for a given time period.

The analysis engine 212 also permits performance analysis of an application to be determined even if the devices assigned to the execution of the application have changed during the queried time period. That is, because the data stored in the topology module 204 and the performance metric store 208 is keyed by timestamp and by port/device identifier to an application, the analysis engine 212 aggregates the various port/devices assigned to the application as a function of time, determines the performance data of the application for the appropriate port/device over the queried time range, and presents the analysis. As a result, the performance of an application is determined even when the topology changes.

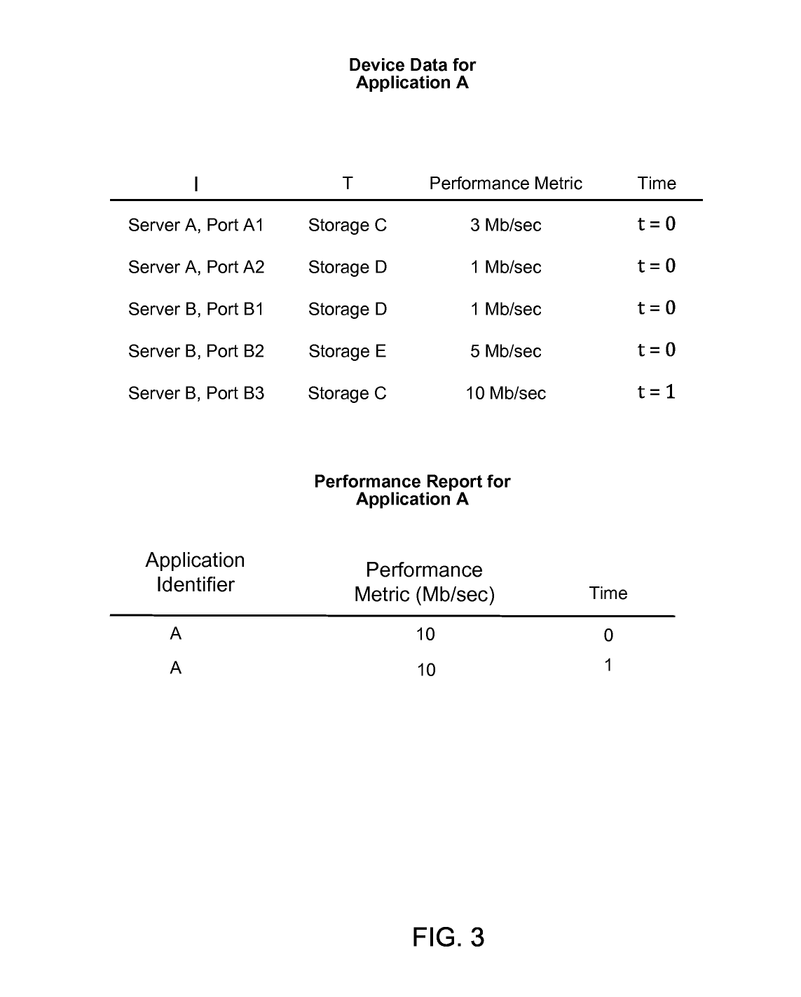

Aggregation of performance metrics for an application includes the application of at least one function and in some cases two functions. In one aspect, performance metric values for all devices composing the entity (or application) are grouped by identical timestamps and aggregated together using a first aggregation function. The first aggregation function produces a series of tuple data sets that include, for example, a timestamp and a corresponding performance metric value. An example of this is shown in the “Device Data for Application A” table of FIG. 3. In another embodiment, the first aggregation function groups timestamps and raw performance data by timestamp and an additional field F to produce tuples (timestamp, f, metric value). In other words, a time series per unique value of F is produced. “F” can be any field designated including, but not limited to, an Application identifier.

If a time series for the application is desired, no further processing is required. If a single value for a range of time is desired, (e.g., as shown in the “Performance Report for Application A” of FIG. 3) then a second aggregation function is applied to the time series. This second aggregation function, typically a reduction function, is used to calculate a single metric value for the range. Examples of reduction functions include, but are not limited to sum and average functions.

While the example system 200 of FIG. 2 shows only an analysis engine 212 for convenience, the functions described above can be shown as being split into two or more engines in other embodiments. In one embodiment, a synchronization engine retrieves relationship information from the topology module 204 to the performance metric store 208. A separate analysis engine correlates the retrieved relationship information with the performance information to produce a query result.

FIG. 3 illustrates a device data report and corresponding performance report for an application executed by different devices as a function of time as a result of the topology changes at times t=0 and t=1. As presented above, a change in the initiating device can result in a change in the performance of an application that would not be identified or understood without also understanding changes in the devices assigned to the application as a function of time. As shown in FIG. 3, however, embodiments of the present disclosure are applied so that the changes in topology and the devices assigned to an application are identified in a performance report. Therefore, changes in application performance are understood as a function of both time and device.

In a first table of FIG. 3, the device data for a particular application (“Application A”) is identified including the various initiators, the various targets, the corresponding performance, and the corresponding times. These data are then used to produce a performance report for “Application A,” as shown in a second table of FIG. 3. This performance report identifies the application, and the performance (in this case, determined by a SUM reducing function) at each of t=0 and t=1.

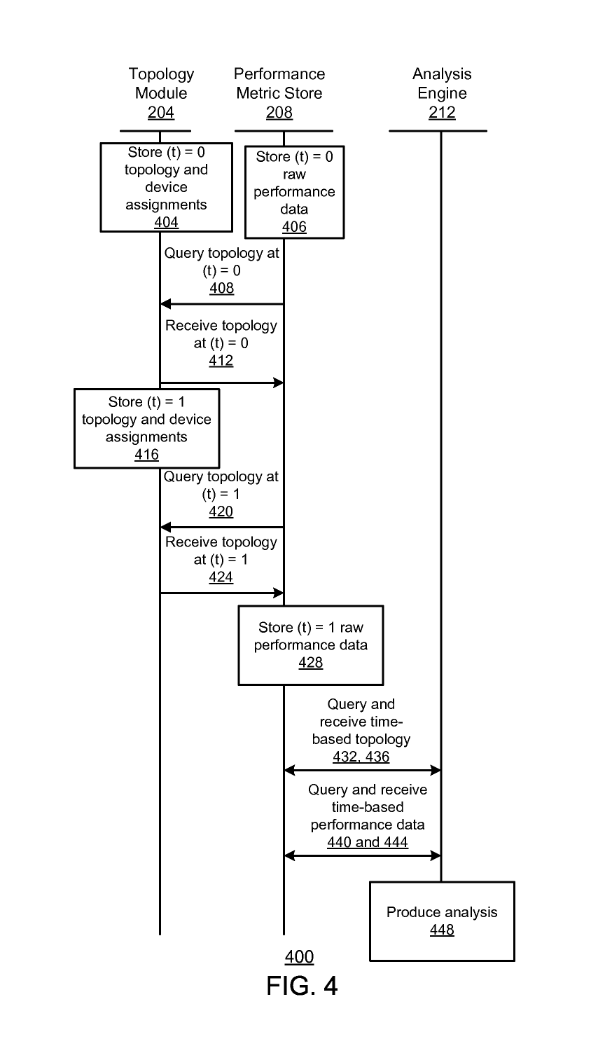

FIG. 4 is a method flow diagram for a method 400 of compiling network performance information as a function of time and analyzing it in the context of the system 200, in an embodiment. The network 100 includes 402 an application at t=0. As part of an updating process, the topology module 204 stores 404 topology and device (or entity or port) assignments at t=0 (or continuously at times between t=0 and t=1). The performance metric store 208 stores 406 raw performance data corresponding to the devices and the conversations between devices at t=0. The performance metric store 208 queries 408 and receives 412 the network topology from the topology module at t=0. The topology module 204 stores 416 topology and device (or entity or port) assignments at t=1. The performance metric store 208 queries 420 and receives 424 the network topology from the topology module at t=1. The performance metric store 208 then stores 428 raw performance data at t=1. The analysis engine 212 then queries 432 and receives 436 time-based topology data and queries 440 and receives 444 time-based performance data. The analysis engine then produces 448 an analysis as described above.

### Computing Machine Architecture

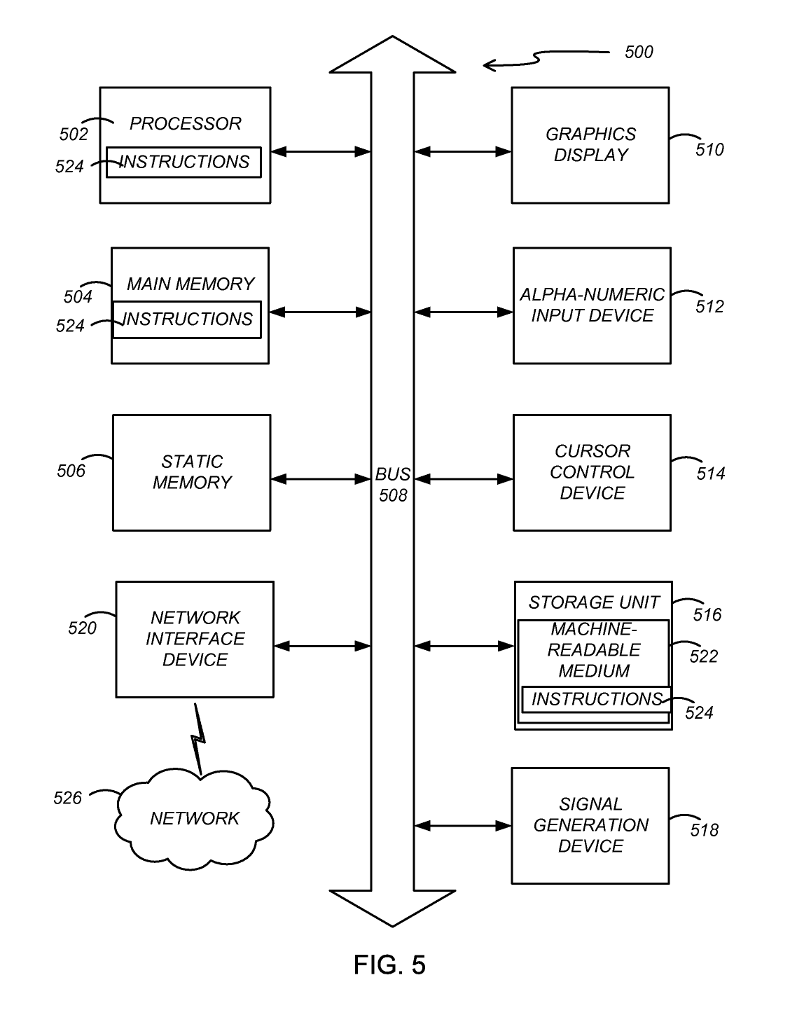

FIG. 5 is a block diagram illustrating components of an example machine able to read instructions from a machine-readable medium and execute those instructions in a processor to perform the machine processing tasks discussed herein, such as the engine operations discussed above. Specifically, FIG. 5 shows a diagrammatic representation of a machine in the example form of a computer system 500 within which instructions 524 (e.g., software) for causing the machine to perform any one or more of the methodologies discussed herein may be executed. In alternative embodiments, the machine operates as a standalone device or may be connected (e.g., networked) to other machines, for instance via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a data store 516, a signal generation device 518 (e.g., a speaker), an audio input device 526 (e.g., a microphone) and a network interface device 520, which also are configured to communicate via the bus 508.

The data store 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (not shown) via network interface 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 5. Alternatively, hardware or software modules may be stored elsewhere within a computing system.

As referenced herein, a computer or computing system includes hardware elements used for the operations described here regardless of specific reference in FIG. 5 to such elements, including for example one or more processors, high speed memory, hard disk storage and backup, network interfaces and protocols, input devices for data entry, and output devices for display, printing, or other presentations of data. Numerous variations from the system architecture specified herein are possible. The components of such systems and their respective functionalities can be combined or redistributed.

### Additional Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A system comprising:
a processor;
a topology module for storing at least one relationship between a network device and an application, the relationship indexed in the topology module using a unique device identifier corresponding to the network device, an application identifier corresponding to the application, and a time index;
a performance metric store for storing at least one performance metric associated with execution of the application, each performance metric associated with the application identifier, the unique device identifier and the time index; and
an analysis engine for analyzing performance of the application as a function of time by querying the topology module and the performance metric store, the querying using the unique device identifier and the time index.

2. The system of claim 1, wherein the unique device identifier comprises a globally unique device port identifier.

3. The system of claim 1, wherein the topology module is further configured for:
identifying a change in the at least one relationship between the network device and the application; and
storing the change in the at least one relationship in the topology module using the application identifier, the unique device identifier, and a time index corresponding to the time of the change.

4. The system of claim 1, further comprising a query module for receiving a user query, wherein the query includes an entity identifier as a search term, the entity identifier corresponding to an entity including at least two devices.

5. The system of claim 1, wherein the analysis engine is further configured analyzing performance of the application, the further configuration comprising:
identifying identical time indexes;
grouping performance metrics corresponding to the identical time indexes; and
aggregating the performance metrics of the identical time indexes using a first aggregation function.

6. The system of claim 5, further comprising applying a second aggregation function to the aggregated performance metrics, the second aggregation function a reduction function.

7. A computer-implemented method comprising:
storing, in a first non-transitory storage medium, at least one relationship between a network device and an application, the relationship indexed using a unique device identifier corresponding to the network device, an application identifier corresponding to the application, and a time index;
storing, in a second non-transitory storage medium, at least one performance metric associated with execution of the application, each performance metric associated with the application identifier, the unique device identifier and the time index;
determining, using a processor, performance of the application as a function of time, the determining comprising:
querying the at least one relationship between a network device and an application, the querying using the application identifier and the time index;
querying the at least one performance metric, the querying using the unique device identifier and the time index; and
aggregating the at least one relationship between a network device and an application and the at least one performance metric, the aggregating based on the time index.

8. The computer-implemented method of claim 7, wherein the unique device identifier comprises a globally unique device port identifier.

9. The computer-implemented method of claim 7, further comprising:
identifying a change in the at least one relationship between the network device and the application; and
storing the change in the at least one relationship using the application identifier, the unique device identifier, and a first time index.

10. The computer-implemented method of claim 7, further comprising receiving a user query regarding performance of the application, wherein the query includes an entity identifier as a search term, the entity corresponding to the entity identifier including at least two devices.

11. The computer-implemented method of claim 7, wherein determining performance of the application comprises:
identifying identical time indexes;
grouping performance metrics corresponding to the identical time indexes; and
aggregating the performance metrics of the identical time indexes using an aggregation function.

12. The computer-implemented method of claim 11, further comprising applying a second aggregation function to the aggregated performance metrics, the second aggregation function a reduction function.

13. A computer program product stored on a non-transitory computer-readable medium that includes instructions that, when loaded into memory, cause a processor to perform a method, the method comprising:
storing, in a first non-transitory storage medium, at least one relationship between a network device and an application, the relationship indexed using a unique device identifier corresponding to the network device, an application identifier corresponding to the application, and a time index;
storing, in a second non-transitory storage medium, at least one performance metric associated with execution of the application, each performance metric associated with the application identifier, the unique device identifier and the time index;
determining, using a processor, performance of the application as a function of time, the determining comprising:
querying the at least one relationship between a network device and an application, the querying using the application identifier and the time index;
querying the at least one performance metric, the querying using the unique device identifier and the time index; and
aggregating the at least one relationship between a network device and an application and the at least one performance metric, the aggregating based on the time index.

14. The computer program product of claim 13, wherein the unique device identifier comprises a globally unique device port identifier.

15. The computer program product of claim 13, further comprising:
identifying a change in the at least one relationship between the network device and the application; and
storing the change in the at least one relationship using the application identifier, the unique device identifier, and a first time index.

16. The computer program product of claim 13, further comprising receiving a user query regarding performance of the application, wherein the query includes an entity identifier as a search term, the entity corresponding to the entity identifier including at least two devices.

17. The computer program product of claim 13, wherein determining performance of the application comprises:
identifying identical time indexes;
grouping performance metrics corresponding to the identical time indexes; and
aggregating the performance metrics of the identical time indexes using an aggregation function.

18. The computer program product of claim 13, further comprising applying a second aggregation function to the aggregated performance metrics, the second aggregation function a reduction function.
